(19) United States
(12) Patent Application Publication
(10) Pub. No.: US 2004/0177384 A1
(43) Pub. Date: Sep. 9, 2004

(54) Channel return method, apparatus, and system

(76) Inventor: Michael Kahn, Westampton, NJ (US)

Correspondence Address: RATNERPRESTIA, P O BOX 980, VALLEY FORGE, PA, 19482-0980, US

(21) Appl. No.: 10/383,487

(22) Filed: Mar. 7, 2003

(51) Int. Cl. H04N 7/16

(52) U.S. Cl. 725/140; 725/152

(57) ABSTRACT

A method, apparatus, and system for returning to a previously viewed channel is disclosed. A user defines a preferred time period for a timed return feature. A viewer then invokes the timed return feature while viewing a primary channel presented on a display device associated with a television receiver. The timed return feature allows the viewer to view channels other than the primary channel during the preferred time period. At the end of the preferred time period, the primary channel is again presented to the viewer on the display device. The preferred time period is retained in memory so that each time the timed return feature is invoked, the preferred time period is used for the timed return feature.

### FIELD OF THE INVENTION

The present invention relates to the field of television tuning and, more particularly, to methods, apparatus, and systems for automatically returning to a previously viewed channel after a period of time.

### BACKGROUND OF THE INVENTION

Television systems currently exist that contain a timed return feature. This feature allows a viewer of a television channel (referred to herein as the “primary channel”) to view channels other than the primary channel during a period of time selected by the viewer and automatically return to the primary channel after the period of time has elapsed. The timed return feature is especially useful for viewing programming of interest on other channels during a lull in the action of a program or a commercial break on the primary channel.

The timed return feature includes a plurality of time period options, e.g., 30, 60, 90, 120, 150, and 180 seconds. Typically, to access the timed return feature of a television, the viewer presses a “timer button” on a remote control associated with the television to select one of the time period options. Each time the timer button is pressed, the time period is sequentially advanced through the time period options. For example, to select a time period of 150 seconds from time period options including 30, 60, 90, 120, 150, and 180 seconds, the timer button is pressed five times. After the time period is selected, the viewer may view other channels on the television for the selected time period. After the selected time period elapses, the timed return feature causes the display of the primary channel.

Often, a viewer wants to select the same time period every time the timed return feature is accessed. Presently, however, each time the viewer accesses the timed return feature, the viewer must sequentially cycle through the available time period options to select the desired time period. Thus, each time the viewer invokes the timed return feature, the viewer must select the time period from the available time period options. For example, to select the time period of 150 seconds, where the time period options include 30, 60, 90, 120, 150, and 180 seconds, the timer button must be pressed five times every time the timed return feature is invoked.

Many viewers find selecting the time period from available time period options every time the timed return feature is invoked to be inconvenient. Accordingly, methods, apparatus, and systems are needed that offer the usefulness of the timed return feature without the inconvenience of requiring the selection of the time period every time the timed return feature is invoked. The present invention fulfils this need among others.

### SUMMARY

The present invention provides a method, apparatus, and system for an improved automatic timed return feature. The present invention satisfies the aforementioned need by allowing a user to designate a preferred time period and storing the preferred time period. Thereafter, whenever the timed return feature is invoked when viewing a tuned channel, the preferred time period is retrieved and the viewer is able to view other channels during the preferred time period before returning to the channel viewed when the timed return feature was invoked. Thus, when invoked, the timed return feature uses the preferred time period rather than requiring the time period to be specified each time. Accordingly, the automatic timed return feature offers greater convenience to program viewers.

A method, apparatus, and systems in accordance with the present invention automatically returns to a channel displayed to a viewer on a display device after a period of time.

The method includes receiving a preferred time period, storing the preferred time period for a timed return feature, receiving from a viewer control device an indicator associated with the timed return feature while tuned to a primary channel, accessing the stored preferred time period responsive to the indicator, allowing tuning to a secondary channel, and automatically tuning to the primary channel when the preferred time period has elapsed.

The apparatus includes a memory that stores a preferred time period for a timed return feature, a tuner that tunes channels for display on the display device, and a processor coupled to the memory and the tuner, the processor configured to receive the preferred time period, store the preferred time period in memory, control the tuner, and receive an indicator associated with the timed return feature from a viewer control device while the tuner is tuned to a primary channel, the processor further configured to access the stored preferred time period within the memory responsive to the indicator, control the tuner responsive to the viewer control device during the preferred time period after each reception of the indicator; and control the tuner to automatically tune to the primary channel when the preferred time period has elapsed.

One system includes means for receiving a preferred time period, means for storing the preferred time period for a timed return feature, means for receiving from a viewer control device an indicator associated with the timed return feature while tuned to a primary channel, means for accessing the stored preferred time period responsive to the indicator, means for tuning to a secondary channel; and means for automatically tuning to the primary channel when the preferred time period has elapsed.

Another system includes memory means for storing a preferred time period for a timed return feature, tuning means for tuning channels for display on the display device, and processing means coupled to the memory means and the tuning means, the processing means configured to receive the preferred time period, store the preferred time period in the memory means, control the tuning means, and receive an indicator associated with the timed return feature from a viewer control device while the tuning means is tuned to a primary channel, the processing means further configured to access the stored preferred time period within the memory means responsive to the indicator, control the tuning means responsive to the viewer control device during the preferred time period after each reception of the indicator, and control the tuning means to automatically tune to the primary channel when the preferred time period has elapsed.

### BRIEF DESCRIPTION OF THE DRAWINGS

The invention is best understood from the following detailed description when read in connection with the accompanying drawings, with like elements having the same reference numerals. This emphasizes that according to common practice, the various features of the drawings are not drawn to scale. On the contrary, the dimensions of the various features are arbitrarily expanded or reduced for clarity. Included in the drawings are the following features:

FIG. 1 is a block diagram of a television receiver in accordance with the present invention;

FIG. 2 is an illustration of a remote control in accordance with the present invention;

FIG. 3 is a flow chart of a timed return routine in accordance with the present invention;

FIG. 4 is a flow chart of a timed return setup menu routine in accordance with the present invention; and

FIG. 5 is a timed return setup menu display for display on the display device of the television receiver of FIG. 1.

### DETAILED DESCRIPTION OF THE INVENTION

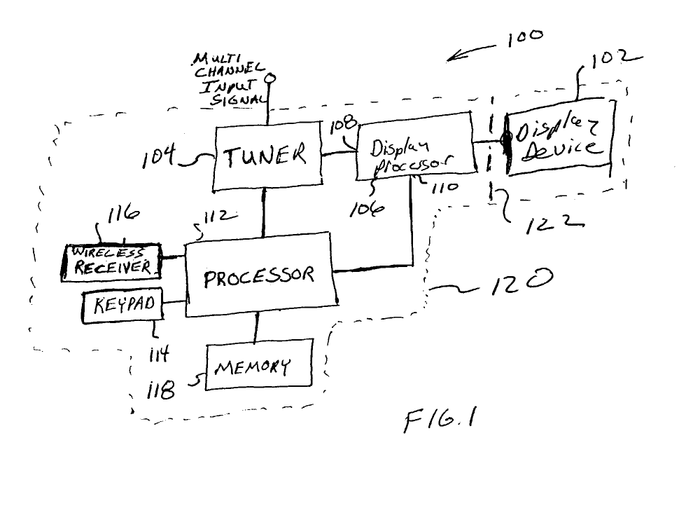

FIG. 1 is a general block diagram of a television receiver 100 for practicing an exemplary embodiment of the invention. The specific circuitry comprising the various blocks as shown in FIG. 1 are conventional, and the detailed design of the individual circuits will be known to those of skill in the art. It will be recognized that while the exemplary embodiment is described in connection with a television receiver 100 having a conventional display device 102, the term “television receiver” as used herein is intended to include not only conventional television sets, but also video cassette recorders, satellite receivers, or any other apparatus capable of tuning a television signal from one or more multiple-channel sources.

In general overview, an exemplary timed return feature in accordance with the present invention enables a viewer of an initial tuned channel (referred to herein as the primary channel) to view channels other than the primary channel (referred to herein as secondary channels) during a commercial break or lulls in a program on the primary channel for a preferred time period. After the preferred period of time, the primary channel is automatically tuned for display so the viewer does not miss desired programming on the primary channel. In the present invention, the preferred time period is set by a user, which may or may not be the viewer, and is stored for future use. Thereafter, each time the timed return feature is invoked, the stored preferred time period is used rather than requiring the time period to be specified every time the timed return feature is invoked.

Referring to FIG. 1, a tuner 104 receives a multi-channel input signal and tunes out all but a selected channel to form a single channel signal for viewing (referred to herein as “tuning” to the selected channel). Those of skill in the art will recognize that the multi-channel input signal received by the turner may be a convention cable input signal, a conventional over-the-air broadcast signal, a signal received from a satellite transmission receiver, or essentially any multi-channel signal for producing a viewable image.

A display processor 106 processes signals for display on the display device 102. The illustrated display processor 106 has a first input port 108 coupled to the tuner 104 to receive the single channel signal tuned by the tuner 104. The display processor 106 processes the single channel signal and produces a display signal for display on the display device 102. In addition, in an exemplary embodiment, the display processor 106 further includes a second input port 110 for receiving an auxiliary signal containing an image for display on the display device 102, e.g., a setup menu that is described in detail below. In an exemplary embodiment, when the auxiliary signal is present at the second input port 110, the display processor 106 further processes the auxiliary signal to produce the display signal. The exemplary display signal may include the processed single channel signal and/or the auxiliary signal. In an exemplary embodiment, if both the processed single channel signal and the auxiliary signal are present at the first and second input ports 108, 110, respectively, the display processor 106 produces a display signal including an image of the auxiliary signal that replaces or overlays the image derived from the single channel signal.

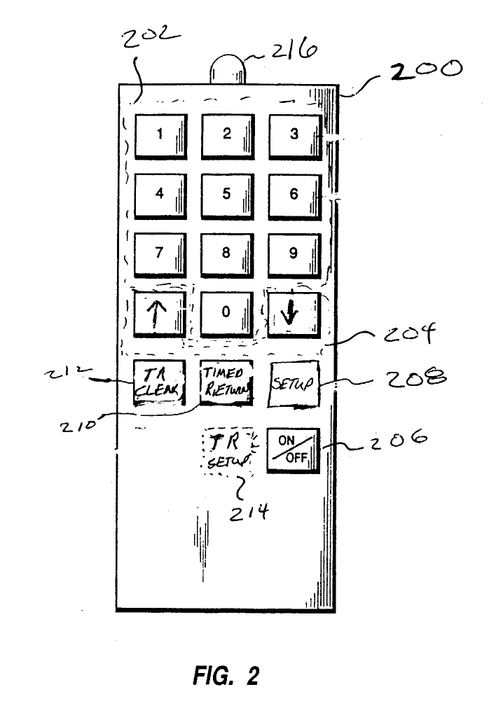

A processor 112 controls the tuner 104 and the display processor 106. The processor 112 may be any conventional programmable microprocessor or other means capable of receiving input control signals and producing corresponding output control signals. In an exemplary embodiment, a keypad 114 and/or a wireless receiver 116 supplies control signals to the processor 112. The keypad 114 is a viewer control device enabling the viewer to supply control signals to the television receiver 100. In an exemplary embodiment, the wireless receiver 116 receives wireless control signals from a remote viewer control device (see FIG. 2). The wireless receiver 116 converts the wireless control signals to electrical signals and passes the electrical signals to the processor 112. Those of skill in the art will recognize that the wireless signals may be infrared (IR) signals, radio signals, or other such signal transmission mediums.

A memory 118 is coupled to the processor 112 for storing a control program that controls the television receiver 100 in accordance with the present invention. In addition, as described in detail below, the memory 118 stores user setup preferences for a timed return feature in accordance with the present invention.

In an exemplary embodiment, the components of the television receiver 100 are contained within a housing 120. In the exemplary embodiment, the housing 120 is a conventional housing used for television receivers. In certain exemplary embodiments, the display device is not included within the housing (illustrated by broken line 122.

FIG. 2 depicts an exemplary remote control 200 suitable for use with the television receiver 100 of FIG. 1. The illustrated remote control 200 includes conventional remote control keys and timed return feature keys for use in accordance with an exemplary embodiment. The conventional keys include numerical keys 202 for entering the digits 0-9, directional keys 204 for entering up and down channel commands, a power key 206 for turning the television receiver 100 (FIG. 1) on/off, and a set-up key 208 for prompting the display on the display device 102 (FIG. 1) of a user set-up preference menu (not shown) for the television receiver 100 (FIG. 1).

In an exemplary embodiment, the timed return feature keys include a timed return key 210 for initiating the timed return feature, a clear timed return key 212 for clearing the timed return feature, and a timed return setup key 214 for initiating a setup routine for initializing the timed return feature, e.g., selecting the preferred time for the timed return feature. In an exemplary embodiment, pressing the timed return key 210 generates a TIMED RETURN indicator signal, pressing the clear timed return key 212 generates a CLEAR indicator signal, and pressing the timed return setup key 214 generates a TIMED RETURN (TR) SETUP indicator. In certain exemplary embodiments, a setup menu for the timed return feature is accessed through the conventional setup key 208, thereby eliminating the need for the timed return setup key 214. The remote control 200 includes electronic circuitry (not shown) for encoding a signal to be transmitted by a conventional wireless transmitting device such as an IR diode 216.

The keys of the remote control 200 may be physical keys of a conventional remote control, designated areas on a touch screen remote control, or essentially any manner of selecting a specified function. In an exemplary embodiment, one or more of the remote keys are also present on the keypad (FIG. 1). In certain exemplary embodiments, some of the keys are present on the remote 200 and some are present on the keypad 114 (FIG. 1). For example, the timed return setup key 214 may be present only on the keypad 114 and the clear timed return and timed return keys 212, 210 may be present only on the remote control 200. The arrangement and location of the individual keys is largely a matter of design consideration and alternative arrangements and locations suitable for use with the present invention will be readily apparent to those of skill in the art.

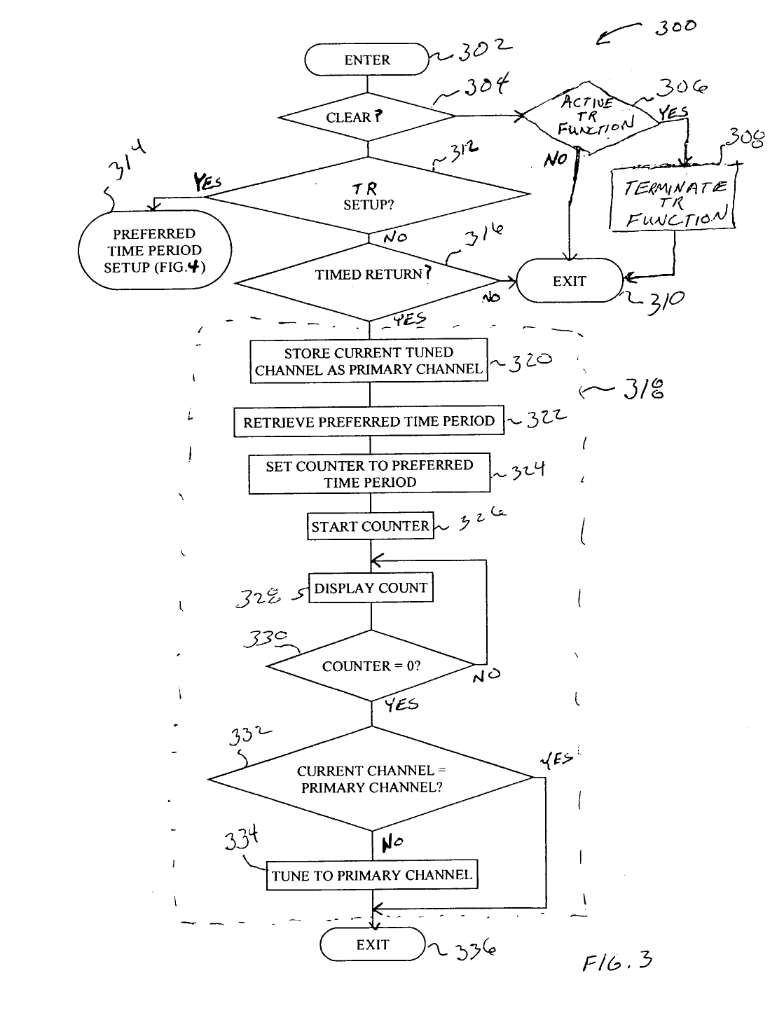

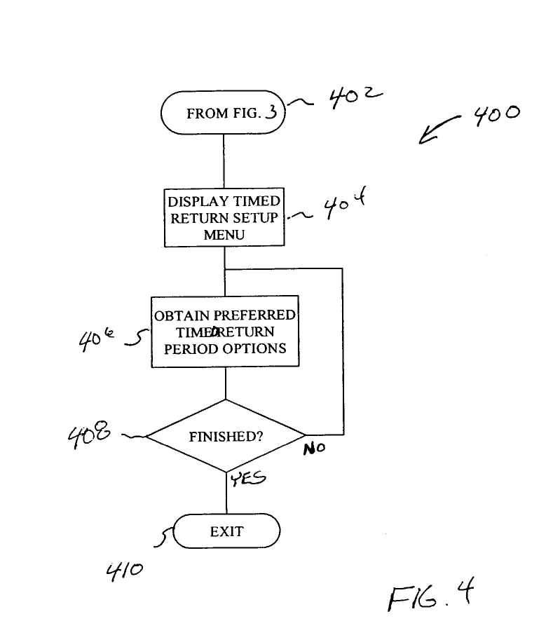

Operation of the apparatus illustrated in FIGS. 1 and 2 is now described with reference to FIGS. 3 and 4.

If a viewer is watching a television program on a primary channel and the television program is interrupted for a commercial break, the viewer may avoid receiving the commercial message by pressing the timed return key 210 (FIG. 2) of the remote control, and then tuning to other channels in the usual way.

When the processor 112 (FIG. 1) receives a control signal from the keypad 114 or wireless receiver 116, the processor enters an indicator decoding routine running on the processor, the relevant portion of which is shown in the flow chart 300 of FIG. 3. At block 302, the processor enters the indicator decoding routine.

At block 304, the processor checks if the received control signal includes the CLEAR indicator. If the CLEAR indicator is present, at block 306, the processor checks if the timed return feature is currently active, e.g., by checking an active flag associated with the timed return feature. If the timed return feature is active, the processor terminates the timed return feature at block 308. The processor then exits the indicator decoding routine at block 310.

At block 312, the processor checks if the received control signal includes the TR SETUP indicator. If the TR SETUP indicator is present, at block 314, a setup routine is entered (see FIG. 4). Otherwise, processing proceeds at block 316.

FIG. 4 depicts the relevant portion of a setup routine 400 for setting the preferred time period of the timed return feature. In an exemplary embodiment, the setup routine 400 is entered at block 402 as a result of the processor receiving the TR SETUP indicator at block 312 (FIG. 3) of the indicator decoding routine depicted in FIG. 3. In an alternative exemplary embodiment, the setup routine is entered through a conventional setup program used to configure other aspects of the television receiver 100 such as adjusting the picture level, adding/subtracting channels from a channel tuning list, setting the current time, etc.

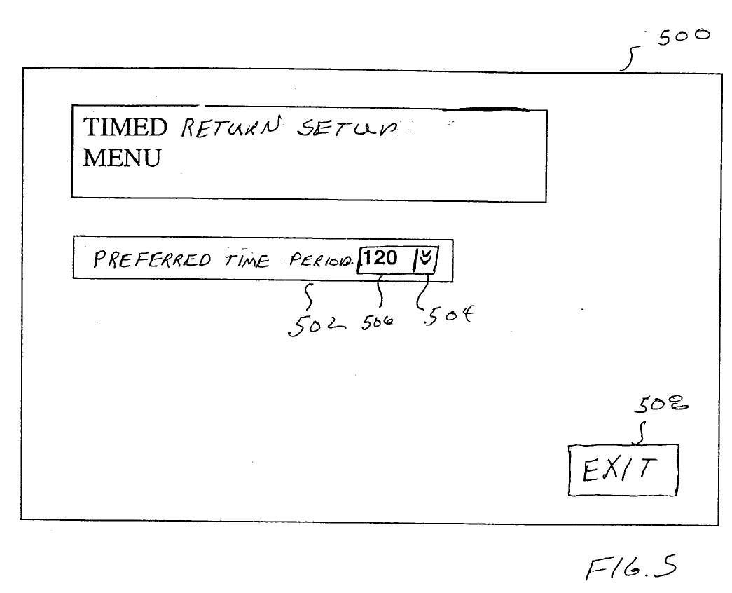

At block 404, the processor generates a timed return setup menu for display, e.g., on the display device 102 (FIG. 1). FIG. 5 depicts an exemplary timed return setup menu 500 for display on the display device. In an exemplary embodiment, prior to setup, the preferred time period is set to a default value, e.g., 120 seconds. The illustrated timed return setup menu 500 includes a preferred time period selection box 502. In an exemplary embodiment, the preferred time period selection box 502 displays one of a plurality of preset values, with the currently displayed value being the current preferred time period. In certain exemplary embodiments, the displayed value is changed by using conventional directional keys 204 (FIG. 2) to cycle through the plurality of preset value. In an alternative exemplary embodiment, the preferred time period selection box 502 includes a drop down menu (not shown) that is accessed by selecting a drop down menu indicator 504 using conventional techniques, e.g., using conventional navigation keys (not shown) on the remote control 200 (FIG. 2). In certain exemplary embodiments, the drop down menu includes a plurality of preset values, e.g., 30, 60, 90, 120, 150, or 180 seconds.

At block 406, the processor obtains a preferred timed return period from a user, which may or not be the viewer invoking the timed return feature. In an exemplary embodiment, the processor obtains the preferred timed return period from the user via a drop down menu of the timed return setup menu 500 (FIG. 5). In accordance with this exemplary embodiment, the user selects a preset value from the drop down menu, e.g., 30, 60, 90, 120, 150, or 180 seconds, that suits the needs of the user.

In an alternative embodiment, the preferred time period is entered directly into a preferred time period entry field 506 using conventional numeric keys 202 (FIG. 2) of the remote control. In this alternative exemplary embodiment, the user generates a preferred time period that is set to essentially any value through the use of the numeric keys on the remote control 200 (FIG. 2) or keypad 114 (FIG. 1), thereby allowing the user to further adjust the preferred time period to suit the needs of the user. For example, assume a commercial break of 60 seconds. If the user typically presses the timed return key 210 (FIG. 2) 5 seconds into the commercial break and the preferred time is set to 60 seconds, the viewer will miss the first 5 seconds of programming after the commercial break. In accordance with the alternative exemplary embodiment, the user sets the preferred time period to 55 seconds. Accordingly, the user is returned to the primary channel after 55 seconds and, thus, the user does not miss any desired programming.

At block 408, the processor checks if the user is finished with the setup of the timed return feature. If the user is not finished, the processor continues to obtain preferred time return period options at block 406. If the user is finished, the processor exits the timed return setup menu at block 410. In an exemplary embodiment, the user indicates that he/she is finished by pressing the timed return setup key 214 to generate the TR SETUP indicator. In this exemplary embodiment, the processor exits the timed return setup routine in response to the TR SETUP indicator. In an alternative exemplary embodiment, the user selects an EXIT button 508 on the display menu in a known manner, e.g., using conventional navigation keys (not shown) on the keypad 114 (FIG. 1) or the remote control 200 (FIG. 2), which generates an indicator instructing the processor to exit the timed return setup routine.

Although the present invention is described using a displayable setup menu for setting the preferred time period, the preferred time period can be selected using essentially any known manner for entering data. In an exemplary embodiment, the user presses the TR SETUP key and the processor accepts values entered using the numeric keys on the remote control during a predefined period, e.g., 5 seconds, without visual feedback. For example, if the user wants to set the preferred time period to 120 seconds, the user presses the TR SETUP key followed by the “1” key, the “2” key, and the “0” key within five seconds. Various alternative embodiments for selecting the preferred time period will be readily apparent to those skilled in the art and are considered within the scope of the present invention.

In certain alternative exemplary embodiments, a secondary time period is set during the setup routine 400. In an exemplary embodiment, the secondary time period extends the preferred time period for returning to a primary channel after the timed return feature is invoked. For example, assume a commercial break of 180 second, a preferred time period of 120 seconds, and a secondary time period of 60 seconds. When the user presses the timed return key 210 (FIG. 2), the user has 120 seconds to view programming on other channels. If, during the preferred time period, the user recognizes that the commercial break will last longer than 120 seconds, the user selects the time return key 210 (FIG. 2) a second time to gain an additional 60 seconds (i.e., a total of 180 seconds or the assumed length of the commercial break) to view programming on other channels. In certain alternative exemplary embodiments, the secondary time period replaces the primary time period, e.g., by pressing the timed return key 210 twice within a predefined period of time, e.g., 3 seconds. The secondary time period can be obtained using any of the techniques described above for obtaining the preferred time period. Various alternative methods for obtaining and using the secondary time period will be readily apparent to those of skill in the art from the above description and are considered within the scope of the present invention. The programming necessary to perform these alternative exemplary embodiments will be readily apparent to those in the field of computer programming.

Referring back to FIG. 3, at block 316, the processor checks if the received control signal includes the TIMED RETURN indicator. If the TIMED RETURN indicator is present, a timed return routine 318 is invoked. If the TIMED RETURN indicator is not present, the processor exits the routine at block 310.

At block 320, the processor stores in the memory 118 (FIG. 1) the channel currently tuned by tuner 104 (FIG. 1), i.e., the primary channel, and, at block 322, the processor retrieves the preferred time period from the memory 118 (FIG. 1).

At block 324, the processor sets a countdown counter equal to the preferred time period and, at block 326, the processor starts the countdown of the counter. During the countdown period, the viewer may view any channel tunable buy the tuner 104 (FIG. 1) under the control of the processor.

At block 328, the processor displays the current count of the counter, e.g., on a television monitor. In certain exemplary embodiments, the processor displays the count only when the time remaining is less than a predefined time period, e.g., less than 10 seconds. In addition, in certain other exemplary embodiments, the displayed count is removed using a conventional display key (not shown) on the remote control or keypad or may be an option turned on/off using the timed return setup menu 500 (FIG. 5). In certain exemplary embodiments, the count is displayed within a remote display area (not shown) on the remote control 200 (FIG. 2). In certain other exemplary embodiments, the count is indicated on the remote control 200 using a visible indicator such as a diode that is illuminated or flashes when the time remaining is less than a predefined time period, e.g., less than 10 seconds. The programming necessary to implement these exemplary embodiments will be readily apparent to those of skill in the art of computer programming. In addition, in certain other embodiments the count is not displayed and block 328 can be eliminated.

At block 330, the processor checks if the counter has reached a value of zero, indicating the preferred time period has elapsed. If the counter does not equal zero, the counter continues to count down and the processor continues to display the counter value at block 328. If the counter does equal zero, processing proceeds to block 332. In an alternative exemplary embodiment, the processor programs a timed interrupt routine that generates an interrupt after a specified period of time. At the end of the specified period of time, the timed interrupt routine generates the interrupt, which indicates that the preferred time period has elapsed. In accordance with this embodiment, the processor is programmed to identify the interrupt and to proceed to block 332 in response to the interrupt.

At block 332, the processor checks if the currently tuned channel equals the primary channel stored at block 320. If the currently tuned channel is other than the primary channel, the processor instructs the tuner to tune to the primary channel. The processor then exits the timed return routine at block 336.

In certain exemplary embodiments, the timed return feature automatically sets up a picture in a picture (PIP) display. The PIP display includes a main display area that corresponds to the entire display area of a display device such as a television monitor and a secondary display area that is much smaller than the main display area, e.g., typically less that one-quarter the size of the main display area. The secondary display area overlays a portion of the main display area, essentially forming a window within the main display for viewing the secondary display area. PIP displays are well known in the art and, therefore, are not described in further detail herein.

In an exemplary PIP embodiment, when the timed return key 210 (FIG. 2) is pressed while viewing a primary channel in a main display area, a PIP display is generated that includes the primary channel in the main display area and in the secondary display area. During the preferred time period, channels other than the primary channel can be viewed in the main display while the primary channel is retained in the secondary display area. After the preferred time period expires, the primary channel is automatically displayed in the main display area and the secondary display area is terminated.

In certain exemplary PIP embodiments, the entire secondary display area flashes toward the end of the preferred time period, e.g., during the last ten seconds. In certain alternative PIP embodiments, the border of the secondary display area or an image within the secondary display area flashes toward the end of the preferred time period. Flashing the secondary display area or a portion thereof provides a readily visible indication to the viewer that the preferred time period is about to expire and, therefore, the primary channel is about to move to the main display area and the secondary display area is about to be terminated. If desired, the viewer may then take action, e.g., by terminating the timed return feature or extending the time for returning to the primary channel.

While a particular embodiment of the present invention has been shown and described in detail, adaptations and modifications will be apparent to one skilled in the art. Such adaptations and modifications of the invention may be made without departing from the scope thereof, as set forth in the following claims.

We claim:

1. A method for returning to a channel displayed to a viewer on a display device after a period of time, the method comprising the steps of:
receiving a preferred time period;
storing the preferred time period for a timed return feature;
receiving from a viewer control device an indicator associated with the timed return feature while tuned to a primary channel;
accessing the stored preferred time period responsive to the indicator;
allowing tuning to a secondary channel; and
automatically tuning to the primary channel when the preferred time period has elapsed.

2. The method of claim 1, wherein the step of automatically tuning to the primary channel comprises at least the steps of:
checking if the primary channel is tuned when the preferred time period has elapsed; and
automatically tuning to the primary channel if it is not tuned when the preferred time period has elapsed.

3. The method of claim 1, wherein the step of receiving the preferred time period comprises at least the step of:
receiving a preferred time period value generated by a user.

4. The method of claim 1, wherein the step of receiving the preferred time period comprises at least the steps of:
receiving timing instruction from the viewer control device;
selecting one of a plurality of time period options responsive to the received timing instructions; and
storing the selected one of the plurality of time period options as the preferred time period.

5. The method of claim 4, wherein the step of receiving timing instructions comprises at least the steps of:
displaying on the display device a menu presenting the time period options;
soliciting feedback for the displayed menu via the viewer control device; and
generating the timing instructions responsive to the feedback from the viewer control device.

6. The method of claim 1, wherein the indicator associated with the timed return feature is generated in response to one press of a single button on the viewer control device.

7. The method of claim 1, wherein the viewer control device is a remote control device.

8. A receiver apparatus for returning to a primary channel displayed to a viewer on a display device after a period of time, the apparatus comprising:
a memory that stores a preferred time period for a timed return feature;
a tuner that tunes channels for display on the display device; and a processor coupled to the memory and the tuner, the processor configured to receive the preferred time period, store the preferred time period in memory, control the tuner, and receive an indicator associated with the timed return feature from a viewer control device while the tuner is tuned to a primary channel, the processor further configured to access the stored preferred time period within the memory responsive to the indicator, control the tuner responsive to the viewer control device during the preferred time period after each reception of the indicator; and control the tuner to automatically tune to the primary channel when the preferred time period has elapsed.

9. The apparatus of claim 8, further comprising:
a display device coupled to the tuner, the display device displaying channels tuned by the tuner.

10. The apparatus of claim 9, wherein said processor is further configured to generate a timer configuration menu for display on the display device for displaying time period options, identify one of the time period options responsive to feedback received via the user control device, and store the identified one of the time period options in the memory.

11. The apparatus of claim 8, wherein the preferred time period is generated by a user and the processor is configured to receive the user generated preferred time period.

12. The apparatus of claim 8, further comprising:
a housing physically coupled to the processor;
wherein the viewer control device is a key pad physically coupled to the housing.

13. The apparatus of claim 8, further comprising a remote control receiving device coupled to the processor wherein the viewer control device is a remote control device.

14. A system for returning to a channel displayed to a viewer on a display device after a period of time, the system comprising:
means for receiving a preferred time period;
means for storing the preferred time period for a timed return feature;
means for receiving from a viewer control device an indicator associated with the timed return feature while tuned to a primary channel;
means for accessing the stored preferred time period responsive to the indicator;
means for tuning to a secondary channel; and
means for automatically tuning to the primary channel when the preferred time period has expired.

15. The system of claim 14, wherein the means for receiving the preferred time period comprises at least:
means for receiving timing instruction from the viewer control device;
means for selecting one of a plurality of time period options responsive to the received timing instructions; and
means for storing the selected one of the plurality of time period options as the preferred time period.

16. The system of claim 17, wherein said means for receiving timing instructions comprises at least:
means for displaying on the display device a menu presenting the time period options;
means for soliciting feedback for the displayed menu via the viewer control device; and
means for generating the timing instructions responsive to the feedback from the viewer control device.

17. A system for returning to a primary channel displayed to a viewer on a display device after a period of time, the system comprising:
memory means for storing a preferred time period for a timed return feature;
tuning means for tuning channels for display on the display device; and
processing means coupled to the memory means and the tuning means, the processing means configured to receive the preferred time period, store the preferred time period in the memory means, control the tuning means, and receive an indicator associated with the timed return feature from a viewer control device while the tuning means is tuned to a primary channel, the processing means further being configured to access the stored preferred time period within the memory means responsive to the indicator, control the tuning means responsive to the viewer control device during the preferred time period after each reception of the indicator; and control the tuning means to automatically tune to the primary channel when the preferred time period has elapsed.

18. The system of claim 17, further comprising:
display means coupled to the tuning means for displaying channels tuned by the tuning means.

19. The system of claim 17, further comprising:
remote control transmitting means for transmitting the indicator associated with the timed return feature; and
remote control receiving means coupled to the processing means for receiving the indicator associated with the timed return feature.
